(19) United States
(12) Patent Application Publication
(10) Pub. No.: US 2004/0148982 A1
(43) Pub. Date: Aug. 5, 2004

(54) Latching device for a lock

(75) Inventors: Wei-Lung Chiang, Chiayi City (TW); Sheen-Youl Gao, Yunlin County (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Tung Lung Metal Industry Co., Ltd.

(21) Appl. No.: 10/760,613

(22) Filed: Jan. 20, 2004

(30) Foreign Application Priority Data
Jan. 20, 2003 (CN) 092201021

(51) Int. Cl. E05B 59/00; E05B 63/14

(52) U.S. Cl. 70/107

(57) ABSTRACT

A latching device for a lock, comprising a housing, a clutch device, a first latch, a first latch driving member, a second latch, a second latch driving member and a latch spring, so as to provide a function of multiple locking actions.

### BACKGROUND OF THE INVENTION

(A) Field of the Invention

The present invention relates to a latching device for a lock, particularly to a latching device for a door lock which is used for building passageways and has an excellent performance against thieves. The present invention has a function of multiple locking actions and is adapted to two different door sizes.

(B) Description of the Relevant Art

The present invention relates to a latching device for a lock, particularly to a latching device for a door lock which is used for building passageways and has an excellent performance against thieves.

When a door is used for a gate, a bedroom, or other private areas, it usually requires a lock with a function of multiple locking actions. Further, standard doors have two different installation distances measured from a keyhole to a door frame: 60 mm and 70 mm. When a door lock is to be used, these two factors have to be considered.

If a door lock is selected according to the dimensions of a building, the desired purposes and the standards thereof, there will be a large number of different door locks required, which increases the amount of stock, as well as the risks of erroneous supply, inappropriate installations, delayed installations, and correcting the installation mistakes. The above facts may result in a considerable increase in costs.

### SUMMARY OF THE INVENTION

Accordingly, to overcome the aforementioned limitations, the present invention alternatively provides a latching device for a lock wherein the latching device has a function of multiple locking actions and the installation distance is adjustable.

It is a primary objective of the present invention to provide a latching device for a lock wherein the latching device has a function of multiple locking actions.

It is a further objective of the present invention to provide a latching device for a lock wherein the installation distance is adjustable.

To achieve the above objectives, the latching device for a lock in accordance with the present invention comprises: a housing, a first latch, a first latch driving member, a second latch, and a second latch driving member, wherein the housing is formed with a hollow chamber and two through holes are formed at the front end of the housing; the first latch driving member is received within the housing and includes a front biasing portion, a rear biasing portion, a projection and a through hole; the first latch is provided with a latch head at the front end thereof, and a front biasing portion and a rear biasing portion at the rear end thereof, the rear biasing portion of the first latch being able to be driven rearward by the rear biasing portion of the first latch driving member for retracting the first latch back to its first position within the housing, and the front biasing portion of the first latch being able to be driven forward by the front biasing portion of the first latch driving member for partly extending the first latch out of the housing to its second position; the second latch is provided with a latch head at the front end thereof and at least one biasing portion at the rear end thereof; and the second latch driving member has a hole for inserting a driving member thereinto, a recess for receiving the projection of the first latch driving member to form an aligned arrangement with relative rotation therebetween, and a biasing portion for biasing the second latch rearward to retract the second latch back to its second position within the housing.

The structure and objectives of the present invention can be more readily understood by persons skilled in the art from the following description of the preferred embodiments taken in conjunction with the accompanying drawings.

### BRIEF DESCRIPTION OF THE DRAWINGS

FIG. 1 is an exploded view of a latching device for a lock in accordance with a first embodiment of the present invention;

FIG. 2 is a partial sectional view of a latching device for a lock in accordance with the first embodiment of the present invention, wherein the first latch is located at its first position;

FIG. 3 is a partial sectional view of a latching device for a lock in accordance with the first embodiment of the present invention, wherein the first latch is located at its second position;

FIG. 4 is a partial sectional view of a latching device for a lock in accordance with the first embodiment of the present invention, wherein the second latch is located at its second position;

FIG. 5 is a partial sectional view showing the combination of the first latch driving member, the second latch driving member, driving members and a crank of a latching device for a lock in accordance with the first embodiment of the present invention;

FIG. 6 is a sectional view taken along Line 6-6 in FIG. 5;

FIG. 7 is an exploded view of a latching device for a lock in accordance with a second embodiment of the present invention;

FIG. 8 is a partial sectional view of a latching device for a lock in accordance with the second embodiment of the present invention, wherein the adjusting member is adapted to a 70 mm installation distance, and the first latch is located at its first position;

FIG. 9 is a partial sectional view of a latching device for a lock in accordance with the second embodiment of the present invention, wherein the adjusting member is adapted to a 60 mm installation distance, and the first latch is located at its first position;

FIG. 10 is a partial sectional view of a latching device for a lock in accordance with the second embodiment of the present invention, wherein the adjusting member is adapted to a 60 mm installation distance, and the first latch is located at its second position;

FIG. 11 is a partial sectional view of a latching device for a lock in accordance with the second embodiment of the present invention, wherein the adjusting member is adapted to a 70 mm installation distance, and the first latch is located at its second position;

FIG. 12 is a partial sectional view showing the combination of the first latch driving member, the second latch driving member, driving members and a crank of a latching device for a lock in accordance with the second embodiment of the present invention;

FIG. 13 is a sectional view taken along Line 13-13 in FIG. 12; and

FIG. 14 is a partial sectional view of a latching device for a lock in accordance with the second embodiment of the present invention, wherein the second latch is located at its second position.

### DETAILED DESCRIPTION OF THE INVENTION

To realize the objectives, characteristics and advantages of the present invention, the latching device for a lock in accordance with a first embodiment of the present invention can be described, with the accompanying drawings, in further detail as follows:

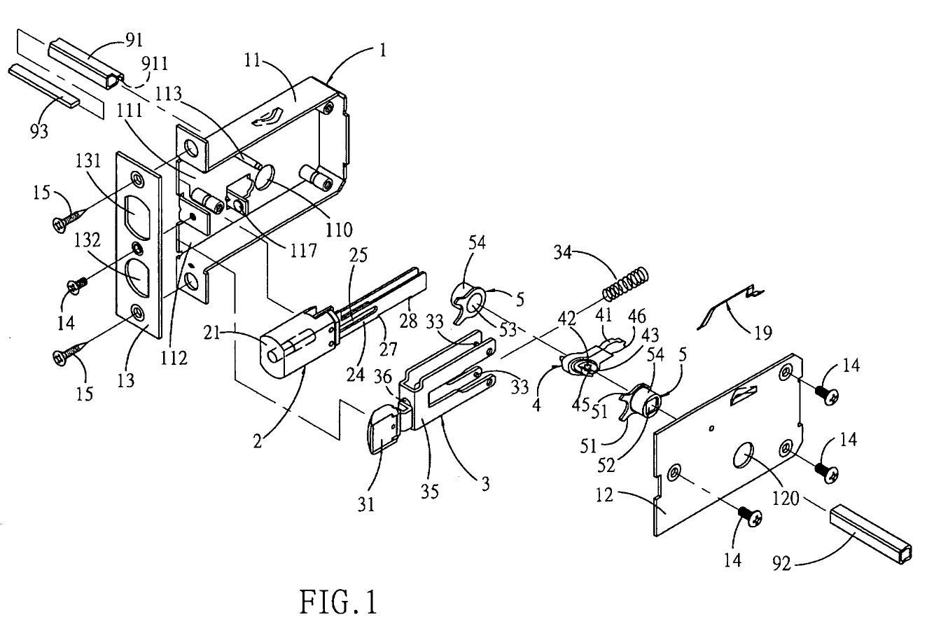

FIG. 1 is an exploded view of the latching device for a lock in accordance with the first embodiment of the present invention. As shown in FIG. 1, the latching device comprises a housing 1, a first latch 2, a second latch 3, a first latch driving member 4, a spring 19, two second latch driving members 5, as well as a latch spring 34.

The housing 1 is mounted to a door panel (not shown) by screwing screws 15 through the through holes formed thereon, and comprises a main body 11, a cover plate 12 and a face plate 13, which are assembled together by screws 14 to form a hollow chamber for installing the members of the latching device therein, wherein the main body 11 has a post 113, a positioning hole 110, a projection 117, as well as two through holes 111, 112; the cover plate 12 has a positioning hole 120; and the face plate 13 has through holes 131, 132.

The first latch driving member 4 is a cam-shaped plate and is mounted within the housing 1 for selectively driving the first latch 2. The front edge of the cam-shaped plate has a front biasing portion 41 and the rear edge thereof has a rear biasing portion 46. In addition, a projection 43 respectively extends from each lateral side of the plate with a first biasing portion 45 formed thereon. Moreover, a through hole 42 is formed through both projections 43.

The first latch 2 is installed within the housing 1. The front end of the first latch 2 has a latch head 21 with a U-shaped body 24 extending rearwards. The U-shaped body 24 comprises a pair of parallel upright plates and a horizontal plate interconnecting the lower edges of the upright plates. Each upright plate is formed with a slot 25 thereon for receiving the post 113 of the main body 11. The horizontal plate further defines a front biasing portion 27 and a rear biasing portion 28, wherein the rear biasing portion 28 of the first latch 2 can be moved rearward by the rear biasing portion 46 of the first latch driving member 4 to move the latch head 21 of the first latch 2 to its first position where the latch head 21 of the first latch 2 is retracted within the housing 1, and the front biasing portion 27 of the first latch 2 can be moved forward by the front biasing portion 41 of the first latch driving member 4 to move the latch head 21 of the first latch 2 to its second position where the latch head 21 extends out of the housing 1.

The second latch 3 is also installed within the housing 1. The front end of the second latch 3 has a latch head 31 with a U-shaped body 35 extending rearwards. The U-shaped body 35 comprises a top face and four parallel upright plates, wherein four parallel upright plates are arranged in two rows and are perpendicular to the top face. A biasing portion 33 is provided on the rear end of each upright plate and a projection 36 is further formed on the top face of the U-shaped body 35.

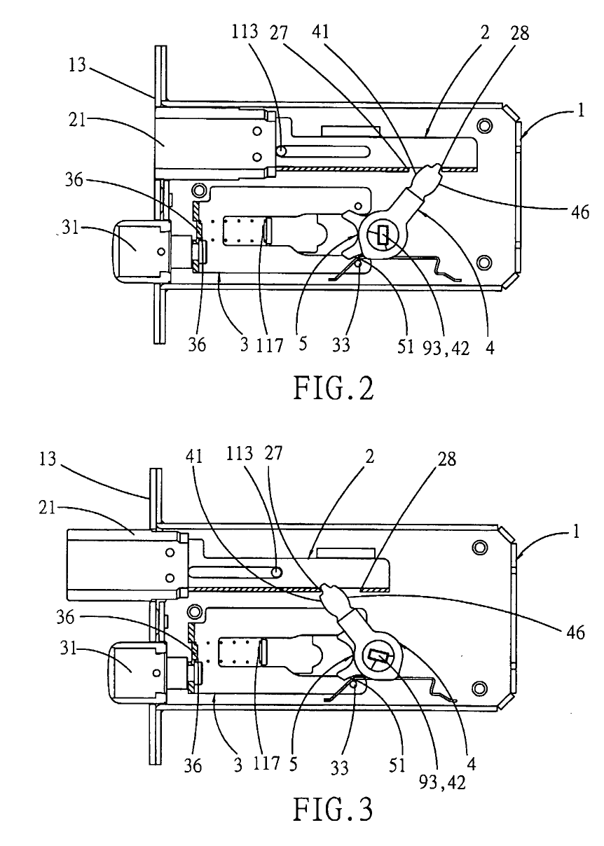

The latch spring 34 is also installed within the housing 11 and is supported between the projection 36 of the second latch 3 and the projection 117 of the main body 11 so as to keep the latch head 31 of the second latch 3 at its first position where the latch head 31 extends out of the housing 1 (see FIG. 2).

The spring 19 is received within the housing 1 and is used to support the first latch driving member 4.

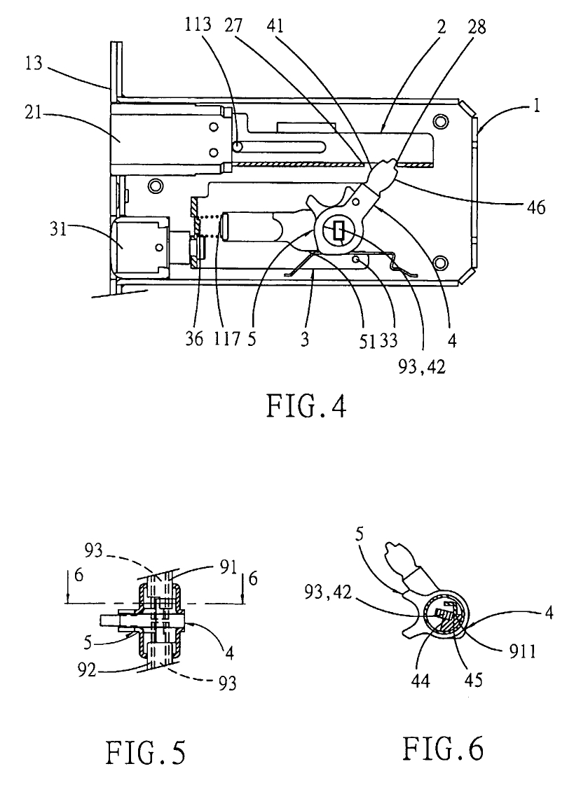

Each second latch driving member 5 comprises a cylinder 54 for being inserted into the positioning hole 110 of the main body 11 and the positioning hole 120 of the cover plate 12, respectively. The cylinder 54 has a hole 52 formed at a side for inserting an inside driving member 91 or an outside driving member 92 thereinto which are elongated pipes with a substantially rectangular cross section (see FIG. 5). The other side of the cylinder 54 is provided with two biasing portions 51 and a recess 53 for receiving the projection 43 of the first latch driving member 4 to form an aligned arrangement with relative rotation therebetween such that when the biasing portions 51 of the second latch driving member 5 are rotated clockwise or counterclockwise to press against either one of the biasing portions 33 of the second latch 3, the latch spring 34 is compressed and the latch head 31 of the second latch 3 is retracted back to its second position within the housing 1 (see FIG. 4).

As shown in FIGS. 2, 3, 5 and 6, a crank 93 is inserted through the through hole 42 of the first latch driving member 4. To operate the latching device to perform the desired locking function, the crank 93 is rotated by either a key (not shown) from the outside of the door (not shown) or a doorknob (not shown) from the inside of the door to press the front biasing portion 41 of the first biasing member 4 against the front biasing portion 27 of the first latch 2 and the latch head 21 of the first latch 2 is then extended out of the housing 1 (see FIG. 3).

As shown in FIGS. 2, 3, 4, 5 and 6, to operate the latching device to perform the desired unlocking function, the crank 93 is rotated by either a key (not shown) from the outside of the door or a doorknob (not shown) from the inside of the door to press the rear biasing portion 46 of the first biasing member 4 against the rear biasing portion 28 of the first latch 2 and the latch head 21 of the first latch 2 is then retracted back into the housing 1 (see FIG. 2). A handle (not shown) mounted to either the inside or the outside of the door is further rotated such that the inside driving member 91 or the outside driving member 92, which connects with the handle, directly drives the second latch driving member 5 for pressing the biasing portion 51 of the second latch driving member 5 against the biasing portion 33 of the second latch 3 and the latch head 31 of the second latch 3 is retracted back into the housing 1 (see FIG. 4) for opening the door.

Alternatively, as shown in FIGS. 2, 3 and 4, only the handle mounted to the inside of the door is rotated to drive the inside driving member 91. The inside driving member 91 has a driving portion 911 extending therefrom. By rotating the handle, the driving portion 911 of the inside driving member 91 drives the first biasing portion 45 formed at a side of the first latch driving member 4 to in turn press the rear biasing portion 46 of the first latch driving member 4 against the rear biasing portion 28 of the first latch 2 and the latch head 21 of the first latch 2 is then retracted back into the housing 1 (see FIG. 2) so as to place the latching device at an unlocked state. In addition, since the inside driving member 91 has a rectangular cross section and engages with the hole 52 of the second latch driving member 5, the biasing portion 51 of the second latch driving member 5 is driven by the inside driving member 91 simultaneously to push the biasing portion 33 of the second latch 3, such that the latch head 31 of the second latch 3 is retracted back to the housing 1 for opening the door (see FIG. 4).

The above latching device in accordance with the first embodiment of the present invention can be modified to the one which is adjustable for being adapted to different installation distances.

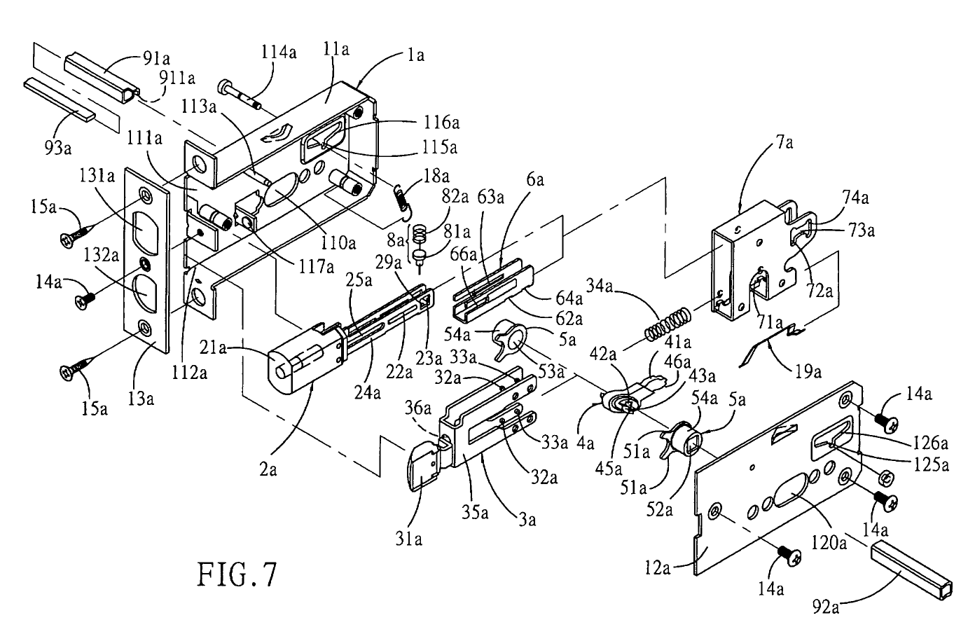

FIG. 7 shows an exploded view of a latching device for a lock in accordance with the second embodiment of the present invention. As shown, the latching device comprises a housing 1a, a first latch 2a, an extension member 6a, a first latch driving member 4a, a second latch 3a, a latch spring 34a, a spring 19a, two second latch driving members 5a, a clutch device 8a, an adjusting member 7a, as well as a pin 114a.

The housing 1a is mounted to a door panel (not shown) by screwing screws 15a through the through holes formed thereon, and comprises a main body 11a, a cover plate 12a and a face plate 13a, which are assembled together by screws 14a to form a hollow chamber for installing the members of the latching device therein, wherein the main body 11 a has a post 113a, a positioning hole 110a, a projection 117a, two through holes 111a, 112a, as well as a T-shaped slot including a vertical slot 115a and a horizontal slot 116a; the cover plate 12a has a positioning hole 120a and a T-shaped slot including a vertical slot 125a and a horizontal slot 126a; and the face plate 13a has through holes 131a, 132a.

The first latch driving member 4a is a cam-shaped plate and is mounted within the housing 1 a for selectively driving the first latch 2a. The front edge of the cam-shaped plate has a front biasing portion 41a and the rear edge thereof has a rear biasing portion 46a. In addition, a projection 43a respectively extends from each lateral side of the plate with a first biasing portion 45a formed thereon. Moreover, a through hole 42a is formed through both projections 43a.

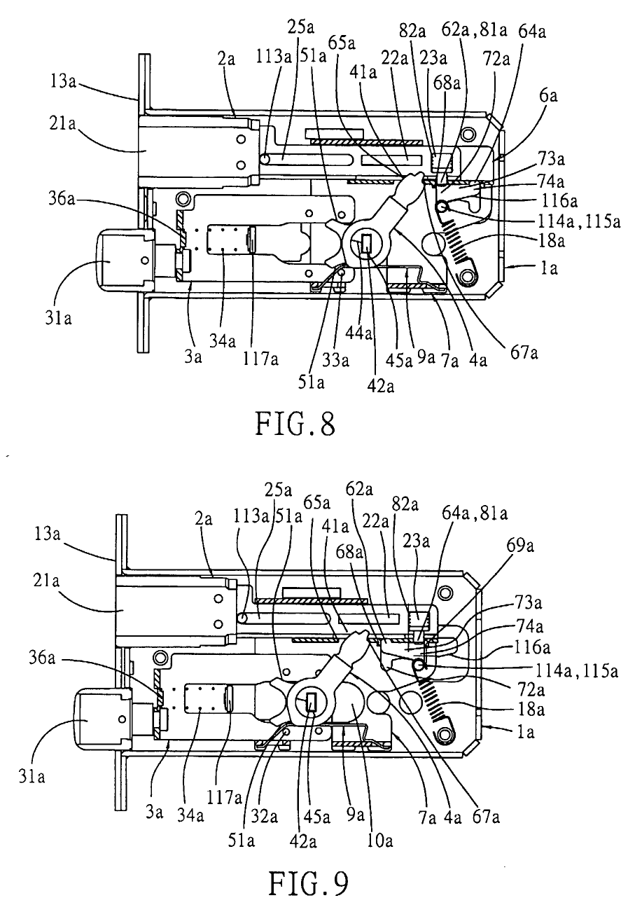

The first latch 2a is installed within the housing 1a. The front end of the first latch 2a has a latch head 21a with a U-shaped body 24a extending rearwards. The U-shaped body 24a comprises a pair of parallel upright plates and a horizontal plate interconnecting the lower edges of the upright plates. On each upright plate is formed with a first slot 25a for receiving the post 113a of the main body 11a, as well as a second slot 22a and a through hole 23a. The horizontal plate further defines a positioning hole 29a which, together with the through holes 23a of the upright plates, receives a positioning member 81a and a positioning spring 82a of the clutch device 8a (see FIG. 8).

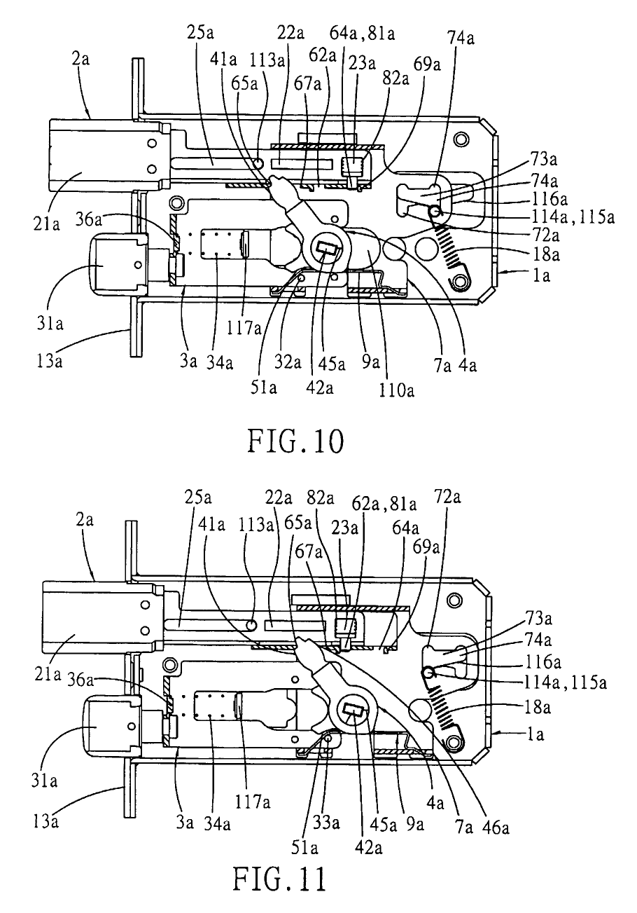

The extension member 6a engages with the rear end of the first latch 2a and is also a U-shaped body comprising a pair of parallel upright plates and a horizontal plate interconnecting the lower edges of the upright plates. On each upright plate is formed with a slot 66a and a sliding portion 63a for slidably mating with the respective second slot 22a of the first latch 2a. The horizontal plate further defines a front biasing portion 65a, a rear biasing portion 67a, a front positioning portion 62a a rear positioning portion 64a, a front projection 68a and a rear projection 69a (see FIG. 9) wherein the front positioning portion 62a and the rear positioning portion 64a selectively engage with the positioning member 81a of the clutch device 8a; the rear biasing portion 67a is biased rearward by the rear biasing portion 46a of the first latch driving member 4a to retract the latch head 21a of the first latch 2a back to its first position within the housing 1a (see FIG. 8 or FIG. 9); and the front biasing portion 65a is biased forward by the front biasing portion 41a of the first latch driving member 4a to move the latch head 21a of the first latch 2a to its second position where the latch head 21a extends out of the housing 1a (see FIG. 10 or FIG. 11).

The second latch 3a is also installed within the housing 1a. The front end of the second latch 3a has a latch head 31a with a U-shaped body 35a extending rearwards. The U-shaped body 35a comprises a top face and four parallel upright plates, wherein four parallel upright plates are arranged in two rows and are perpendicular to the top face. A front biasing portion 32a and a rear biasing portion 33a are provided on the rear end of each upright plate and a projection 36a is further formed on the top face of the U-shaped body 35a.

The spring 19a is received within the housing 1a and is used to support the first latch driving member 4a.

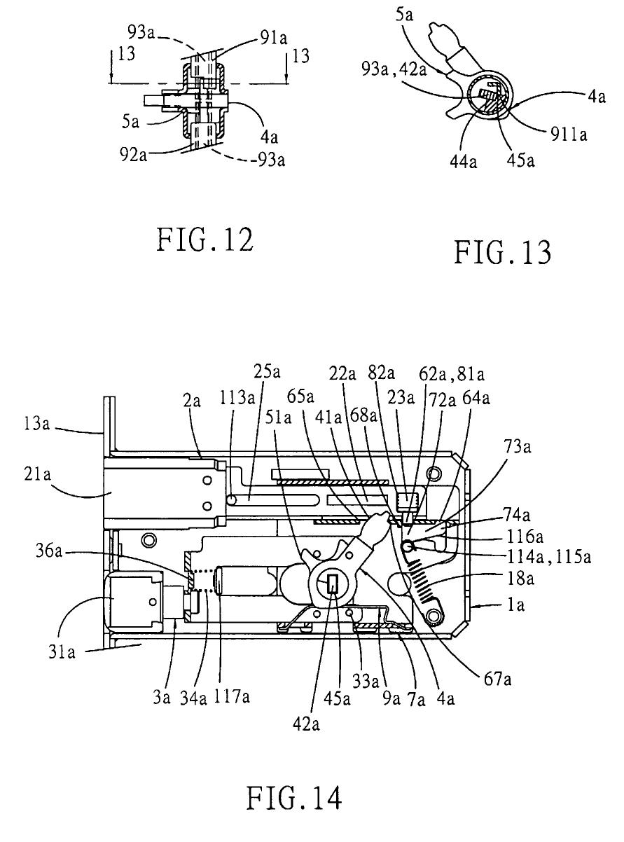

Each second latch driving member 5a comprises a cylinder 54a for being inserted into the positioning hole 110a of the main body 11a and the positioning hole 120a of the cover plate 12a, respectively. The cylinder 54a has a hole 52a formed at a side for inserting an inside driving member 91a or an outside driving member 92a thereinto which are elongated pipes with a substantially rectangular cross section (see FIG. 12). The other side of the cylinder 54a is provided with two biasing portions 51a and a recess 53a for receiving the projection 43a of the first latch driving member 4a to form an aligned arrangement with relative rotation therebetween and be controlled by the inner driving member 91a, the outer driving member 92a and cranks 93a (see FIG. 12).

Moreover, the second latch 3a is supported by the latch spring 34a located between the projection 36a of the second latch 3a and the projection 117a of the main body 11a, such that the latch head 31a of the second latch 3a is at its first position where the latch head 31a extends out of the housing 1a (see FIG. 8 and FIG. 10). Accordingly, when the biasing portions 51a of the second latch driving member 5a are rotated clockwise or counterclockwise to press against the front biasing portion 32a or the rear biasing portion 33a of the second latch 3a, the latch spring 34a is compressed and the latch head 31a of the second latch 3a is retracted back to its second position within the housing 1a (see FIG. 14).

The adjusting member 7a is in the shape of a substantially hollow parallelepiped body and is received within the housing 1a. Each side wall of the adjusting member 7a is formed with a driving portion 71a and a H-shaped slot which includes a front vertical slot 72a, a horizontal slot 73a and a rear vertical slot 74a.

The pin 114a passes through the T-shaped slot of the main body 11a, the H-shaped slots of the adjusting member 7a and the T-shaped slot of the cover plate 12a, and is used to operate the positioning member 81a of the clutch device 8a and push the extension member 6a for selectively engaging the positioning member 81a of the clutch device 8a with the front positioning portion 62a or the rear positioning portion 64a. In addition, the driving portions 71a of the adjusting member 7a push the first latch driving member 4a and the second latch driving member 5a to slidably move them within a range defined by the positioning hole 110a of the main body 11a and the positioning hole 120a of the cover plate 12a for the first latch driving member 4a to operate the first latch 2a and the second latch driving member 5a to operate the second latch 3a.

As shown in FIGS. 8 and 9, to adjust the installation distance of the latching device from 70 mm (see FIG. 8) to 60 mm (see FIG. 9), the pin 114a is moved upward to move the positioning member 81a upward and disengage the positioning member 81a from the front positioning hole 62a of the extension member 6a, while the pin 114a is partly located at the front positioning portion 62a. The pin 114a is then moved horizontally forward to drive the front projection 68a of the extension member 6a such that the extension member 6a is moved forward to a desired position to align the rear positioning portion 64a of the extension member 6a with the positioning member 81a, whereby the positioning member 81a is moved downward under the force of the positioning spring 82a so as to engage it with the rear positioning portion 64a (see FIG. 9).

Moreover, when the pin 114a is moved horizontally forward, the driving portions 71a of the adjusting member 7a drive the cylinders 54a of the second latch driving members 5a to further drive the first latch driving member 4a which is held between two second latch driving members 5, to move forward and the second latch driving members 5 are operative to the front biasing portions 32a. At this moment, under the force of a spring 18a, the pin 114a moves along the horizontal slot 116a of the main body 11a and the corresponding horizontal slot 126a of the cover plate 12a, to the vertical slot 115a of the main body 11a and the corresponding vertical slot 125a of the cover plate 12a.

As shown in FIGS. 8 and 9, to adjust the installation distance of the latching device from 60 mm (see FIG. 9) to 70 mm (see FIG. 8), the pin 114a is moved upward to move the positioning member 81a upward and disengage the positioning member 81a from the rear positioning hole 64a of the extension member 6a, while the pin 114a is partly located at the rear positioning portion 64a. The pin 114a is then moved horizontally rearward to drive the rear projection 69a of the extension member 6a such that the extension member 6a is moved rearward to a desired position to align the front positioning portion 62a of the extension member 6a with the positioning member 81a, whereby the positioning member 81a is moved downward under the force of the positioning spring 82a so as to engage it with the front positioning portion 62a (see FIG. 8).

Moreover, when the pin 114a is moved horizontally rearward, the lo driving portions 71a of the adjusting member 7a drive the cylinders 54a of the second latch driving members 5a to further drive the first latch driving member 4a which is held between two second latch driving members 5, to move rearward and the second latch driving members 5 are operative to the rear biasing portions 33a. At this moment, under the force of a spring 18a, the pin 114a moves along the horizontal slot 116a of the main body 11a and the corresponding horizontal slot 126a of the cover plate 12a, to the vertical slot 115a of the main body 11a and the corresponding vertical slot 125a of the cover plate 12a.

As shown in FIGS. 9, 12 and 13, the crank 93a is inserted through the through hole 42a of the first latch driving member 4a. To operate the latching device with a 60 mm installation distance to perform the desired locking function, the crank 93a is rotated by either a key (not shown) from the outside of the door (not shown) or a doorknob (not shown) from the inside of the door to press the front biasing portion 41a of the first biasing member 4a against the front biasing portion 65a of the extension member 6a to further drive the first latch 2a, and the latch head 21a of the first latch 2a is then extended out of the housing 1a (see FIG. 10).

As shown in FIGS. 10,12 and 13, to operate the latching device with a 60 mm installation distance to perform the desired unlocking function, the crank 93a is rotated by either a key (not shown) from the outside of the door or a doorknob (not shown) from the inside of the door to press the rear biasing portion 46a of the first biasing member 4a against the rear biasing portion 67a of the extension member 6a to further drive the first latch 2a and the latch head 21a of the first latch 2a is then retracted back into the housing 1a (see FIG. 9). A handle (not shown) mounted to either the inside or outside of the door is further rotated such that the inside driving member 91a or the outside driving member 92a, which connects with the handle, directly drives the second latch driving member 5a for pressing the biasing portion 51a of the second latch driving member 5a against the front biasing portion 32a of the second latch 3a and the latch head 31a of the second latch 3a is retracted back into the housing 1a for opening the door.

Alternatively, as shown in FIGS. 12 and 13, only the handle mounted to the inside of the door is rotated to drive the inside driving member 91a. The inside driving member 91a has a driving portion 911a extending therefrom. By rotating the handle, the driving portion 911a of the inside driving member 91a drives the first biasing portion 45a formed at a side of the first latch driving member 4a to in turn press the rear biasing portion 46a of the first latch driving member 4a against the rear biasing portion 67a of the extension member 6a to further push the first latch 2a and the latch head 21a of the first latch 2a is then retracted back into the housing 1a (see FIG. 9) so as to place the latching device at an unlocked state. In addition, since the inside driving member 91a has a rectangular cross section and engages with the hole 52a of the second latch driving member 5a, the biasing portion 51a of the second latch driving member 5a is driven by the inside driving member 91a simultaneously to push the front biasing portion 32a of the second latch 3a, such that the latch head 31a of the second latch 3a is retracted back to the housing 1a for opening the door.

When a building is under construction, the orientation of a door is an important factor in influencing the comfort and the convenience inside the building. The inward or outward opening of the door, as well as the location of hinges will effect the arrangement of the latching device. The present invention can be modified to be adapted to a leftward opened door or a rightward opened door by detaching the face plate 13a, rotating the latch head 31a of the second latch 3a 180° and detaching the face plate 13a.

The above descriptions have clearly illustrated the important features, operational methods and applications of the present invention. Although the invention has been described with reference to the preferred embodiments, it will be obvious to persons skilled in the art that various changes and modifications may be made without departing from the scope of the invention as recited in the claims.

What is claimed is:

1. A latching device for a lock, comprising a housing, a first latch, a first latch driving member, a second latch, and a second latch driving member, wherein:
said housing is formed with a hollow chamber;
said first latch driving member is received within said housing and includes a front biasing portion, a rear biasing portion, a projection and a through hole;
said first latch has a front end which is provided with a latch head, and a rear end which is provided with a front biasing portion and a rear biasing portion, said rear biasing portion of said first latch being able to be driven rearward by said rear biasing portion of said first latch driving member for retracting said first latch back to its first position within said housing, and said front biasing portion of said first latch being able to be driven forward by said front biasing portion of said first latch driving member for partly extending said first latch out of said housing to its second position;
said second latch has a front end which is provided with a latch head, and a rear end which is provided with at least one biasing portion; and
said second latch driving member has a hole for a driving member being inserted therethrough, a recess for receiving said projection of said first latch driving member to form an aligned arrangement being capable of relatively rotating therebetween, and a biasing portion for biasing said second latch rearward to retract said second latch back to its second position within said housing.

2. A latching device for a lock, comprising a housing, a first latch, an extension member, a first latch driving member, a second latch, a second latch driving member, a clutch device, an adjusting member and a pin, wherein:
said housing is formed with a hollow chamber;
said clutch device includes a positioning member and a positioning spring;
said first latch driving member is received within said housing and includes a front biasing portion, a rear biasing portion and a through hole;
said first latch has a front end which is provided with a latch head, and a rear end which is formed with at least one through hole and positioning hole for receiving said clutch device;
said extension member has a front biasing portion and a rear biasing portion, said rear biasing portion of said extension member being able to be driven rearward by said rear biasing portion of said first latch driving member for retracting said first latch back to its first position within said housing, and said front biasing portion of said extension member being able to be driven forward by said front biasing portion of said first latch driving member for extending said first latch out of said housing to its second position;
said second latch has a front end which is provided with a latch head, and a rear end which is provided with at least one biasing portion;
said second latch driving member has a hole for a driving member being inserted therethrough, and a biasing portion for biasing said second latch rearward to retract said second latch back to its second position within said housing;
said pin is received within said housing for operating said adjusting member and said clutch device, and for driving said extension member to selectively engage with said positioning member of said clutch device; and
said adjusting member is able to drive said first latch driving member and said second latch driving member to their respective desired locations such that said first latch driving member and said second latch driving member are adapted to operate said first latch and said second latch, respectively.

3. The latching device for a lock according to claim 2, wherein said extension member further comprises a front positioning portion and a rear positioning portion, for being selectively engaged by said positioning member of said clutch device.

4. The latching device for a lock according to claim 2, wherein said first latch further has a slot formed adjacent to said through hole thereof and said extension member also has a sliding portion for slidably mating with said slot of said first latch.

5. The latching device for a lock according to claim 2, wherein said first latch driving member further has a first biasing portion which is adapted to be driven by a driving portion of a driving member of a lock.

6. The latching device for a lock according to claim 2, wherein said extension member further has a front projection and a rear projection which is adapted to be driven by said pin.

7. A latching device for a lock, comprising a housing, a first latch, a first latch driving member, a second latch, and a second latch driving member, wherein:
said housing is formed with a hollow chamber;
said first latch has a front end which is provided with a latch head, and a rear end;
said first latch driving member is received within said housing and being capable of selectively driving said first latch;
said second latch has a front end which is provided with a latch head, and a rear end which is provided with at least one first biasing portion and at least one rear biasing portion;
said second latch driving member has a hole for a driving member being inserted therethrough, and a biasing portion for biasing said second latch rearward to retract said second latch back to its second position within said housing.

8. The latching device for a lock according to claim 7, further comprising an extension member engaged with said rear end of said first latch.
